(19) United States
(12) Patent Application Publication
(10) Pub. No.: US 2007/0002571 A1
(43) Pub. Date: Jan. 4, 2007

(54) Adaptive lighting system for motor vehicles

(75) Inventors: Milan Cejnek, Novy Jicin (CZ); Martin Mynarik, Novy Jicin (CZ)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/287,832

(22) Filed: Nov. 28, 2005

(30) Foreign Application Priority Data
Jul. 4, 2005 (CZ) PV 2005-435

(51) Int. Cl. G01B 13/18

(52) U.S. Cl. 362/460

(57) ABSTRACT

A lighting system for a motor vehicle adapts to vehicle speed and weather conditions. Each light assembly has a primary light unit and a secondary light unit, and may also include a tertiary light unit. The primary light units produce a beam pattern including a high beam and a low beam, while the secondary light units produce a beam pattern including a low beam and tertiary light units produce a beam patter included low side beams. A controller is operatively connected to the light assemblies for controlling the operation of the primary, secondary and tertiary light units. The controller receives information on vehicle speed or weather or direction or other user input, and operates the primary, secondary and tertiary light units accordingly.

### CROSS-REFERENCE TO RELATED PATENT APPLICATION

This patent application claims the benefit of Czech Republic Patent Application No. PV 2005-435 filed Jul. 4, 2005.

### FIELD OF THE INVENTION

The present invention relates generally to lighting systems for a motor vehicle, and more particularly relates to a lighting system which adapts to driving conditions.

### BACKGROUND OF THE INVENTION

For many years automobile manufacturers have been striving to improve roadway illumination by various vehicle lighting configurations. For example, many modern vehicles include daytime running lights where the vehicle's headlights are illuminated constantly during daylight to make the vehicles more noticeable. Many vehicles also include lighting systems which detect low light levels and energize the headlamps. As another example, U.S. Pat. No. 6,761,476, commonly owned by the assignee of the present application, the disclosure of which is hereby incorporated by reference in its entirety, discloses a multi-axis swivel mechanism which permits the headlights mounted thereto to be directed based on the vehicle direction.

Despite these and other improvements to lighting systems for motor vehicles, there remains a need to provide a lighting system which is increasingly adaptable to driving conditions such as vehicle speed and weather conditions on the roadway.

### BRIEF SUMMARY OF THE INVENTION

The present invention provides a lighting system for a motor vehicle that is sufficiently robust to adapt to vehicle speed and weather conditions. In one embodiment constructed in accordance with the teachings of the present invention, the lighting system generally includes a left light assembly and a right light assembly. Each light assembly has a primary light unit and a secondary light unit. The primary light units produce a beam pattern including a high beam and a low beam, while the secondary light units produce a beam pattern including at least a low beam. A controller is operatively connected to the left and right light assemblies for controlling the operation of the primary and secondary light units, and also receives information on vehicle speed. The controller operates only the primary light units when the vehicle speed is below a predetermined value. The controller operates both the primary and secondary light units when the vehicle speed is above the predetermined speed value.

According to more detailed aspects, the predetermined speed value is preferably in the range of about 40 kmph to 100 kmph (about 25 mph to 62 mph). The beam pattern of the primary light units circumscribes the beam pattern of the secondary light units, resulting in a reduced side spread at higher speeds. The left and right assemblies may further include a tertiary light unit, the tertiary light unit producing a beam pattern including a low beam beamed substantially to the left and right, respectively, of the vertical axis. The controller receives information on a direction of the vehicle, and operates the tertiary light unit of the left light assembly when the vehicle turns left and operates the tertiary light unit of the right light assembly when the vehicle turns right. The tertiary light units may also be operated only when the vehicle speed is below the predetermined value. The controller may further receive information on weather affecting the vehicle and operate only the secondary and tertiary light units when there are wet conditions, and operate only the primary light units in the tertiary light units when there are fog conditions. The primary light units may be pivotally mounted, and the controller may rotate the primary light units to the left when the vehicle turns left and rotate the primary light units to the right when the vehicle turns right.

In another embodiment constructed in accordance with the teachings of the present invention, the lighting system generally includes a left light assembly and a right light assembly. The left and right light assemblies each have a primary light unit and a secondary light unit. The primary light units produce a beam pattern including a high beam and a low beam, while the secondary light units produce a beam pattern including a low beam. The beam pattern of the secondary light units has a lower vertical cut-off above a lower edge of the beam pattern of the primary light units.

According to more detailed aspects of this embodiment, the lower vertical cut-off is linear and about 5 to 10 degrees below the vertical axis. The vertical beam spread of the secondary light units is preferably less than a vertical beam spread of the primary light units. Likewise, the horizontal beam spread of the secondary light units is preferably less than a horizontal beam spread of the primary light units. Most preferably, the horizontal beam spread of the secondary light units is about 34 to 62 degrees, while the horizontal beam spread of the primary light units is about 50 to 90 degrees. The beam pattern of the primary light units may be centered on the horizontal and vertical axes, while the beam pattern on the secondary light units is centered on the horizontal axis. A tertiary light unit may be further employed in the left and right light assemblies, and include a low beam substantially to the left and right of the vertical axis. Most preferably, the beam pattern of each tertiary light unit extends horizontally to a point at least 60 degrees from the vertical axis. Thus, the beam pattern of the tertiary light units have a horizontal spread greater than the horizontal spread of the beam pattern of the primary light units.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a front view of a vehicle employing the lighting system constructed in accordance with the teachings of the present invention;

FIG. 2 is a graphical depiction of the beam pattern produced by the primary light units of the lighting system of FIG. 1;

FIG. 3 is a graphical depiction of the beam pattern produced by the secondary light units of the lighting system depicted in FIG. 1;

FIG. 4 is a graphical depiction of the beam pattern produced by the tertiary light units of the lighting system depicted in FIG. 1;

FIG. 5 is a graphical depiction of the high speed, low beam, beam pattern produced by a combination of the primary and secondary light units of the lighting system depicted in FIG. 1;

FIG. 6 is graphical depiction of the high speed, high beam, beam pattern produced by a combination of the primary and secondary light units of the lighting system depicted in FIG. 1;

FIG. 7 is a graphical depiction of a wet road beam pattern produced by a combination of the secondary and tertiary light units of the light system depicted in FIG. 1;

FIG. 8 is graphical depiction of a fog beam pattern produced by a combination of the primary and tertiary light units of the lighting system depicted in FIG. 1;

FIG. 9 is a graphical depiction of a left turn beam pattern produced by a combination of the primary and tertiary light units of the lighting system depicted in FIG. 1; and

FIG. 10 is a graphical depiction of a right turn beam pattern produced by a combination of the primary and tertiary light units of the lighting system depicted in FIG. 1.

### DETAILED DESCRIPTION OF THE INVENTION

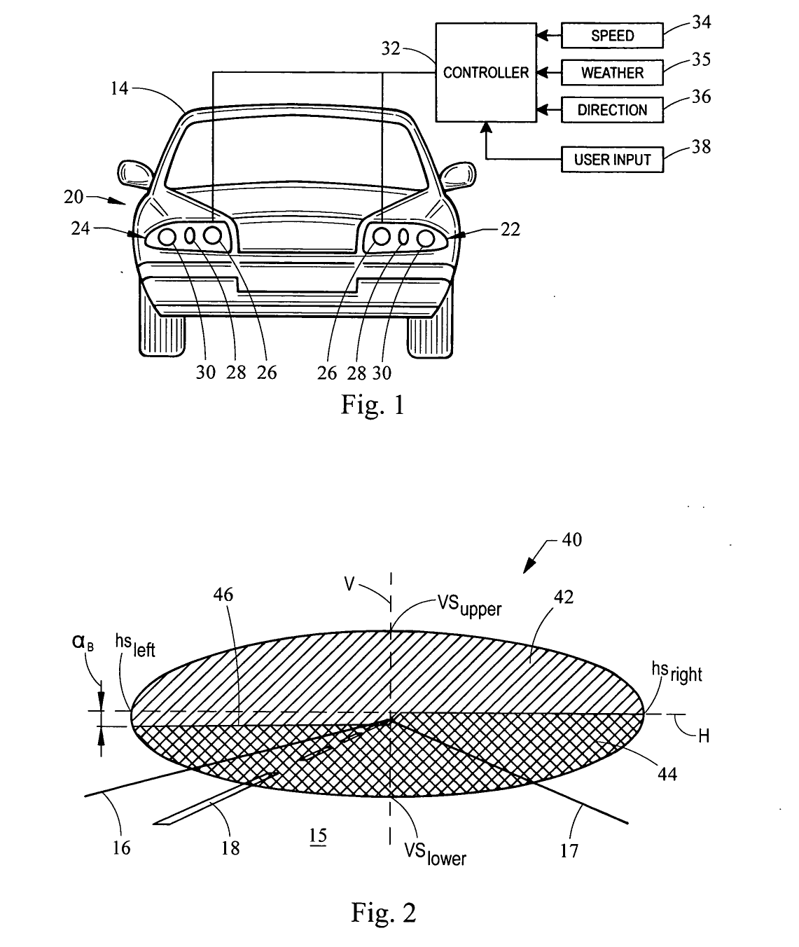

Turning now to the figures, FIG. 1 depicts a front view of a motor vehicle 14 having a lighting system 20 constructed in accordance with the teachings of the present invention. The lighting system 20 generally includes a left light assembly 22 and a right light assembly 24. As used herein, left and right refer to the left and right from the perspective of a driver of the vehicle 14. Both the left and right light assemblies 22, 24 include a primary light unit 26, a secondary light unit 28 and a tertiary light unit 30. The primary light units 26 are positioned at the inner edge (i.e. towards the vehicle center) within the light assembly 22, 24, followed by the secondary light unit 28 in the middle and the tertiary light unit 30 at the outermost position (away from the center) within the light assembly 22, 24. It will be recognized that the positioning of the three light units 26, 28, 30 may be varied and arranged in any desired pattern.

The primary light units 26 are preferably of the projector type, and preferably include both a high beam and a low beam, such as the HID unit disclosed in U.S. Pat. No. 6,186,651, the disclosure of which is hereby incorporated by reference in its entirety. Furthermore, the primary light units are preferably mounted for rotation (as will be discussed in more detail below), exemplary light units being disclosed in U.S. Pat. No. 6,761,476 and EP 1052446, the disclosures of which are also hereby incorporated by reference in their entirety. As used herein high beam refers to a beam pattern having light above a horizontal axis, and low beam means a beam pattern having a majority of light below the horizontal axis. It will be recognized that virtually any type of head lamp may be used as the primary light unit 26 so long as a high beam and a low beam are provided. As is well known in the art, high and low beams may be produced through multiple light sources (i.e. multiple filaments) and/or through the use of shields and reflectors which may be operated to cut-off a portion of the light to provide high and low beams. The secondary light units 28 also produce a beam pattern including a high beam and a low beam, although the present invention may be readily employed through the use of secondary light units 28 which only have a low beam.

The tertiary light units 30 provide at least a low beam directed to the side, as will be described in more detail below. The lighting system 20 also preferably includes a controller 32 regulating the operation of the left and right light assemblies 22, 24, and in particular controlling the energization of the individual primary, secondary and tertiary light units 26, 28, 30. The controller 32, which may comprise any type of controller such as a central processing unit or other processor, circuit, or chip, determines the operation of the light units 26, 28, 30 based on a variety of variables including vehicle speed 34, road conditions or weather 35, vehicle direction 36, and various user input 38 such as a manual control for switching between high and low beam. As will be recognized by those skilled in the art, information on vehicle speed 34 may be provided to the controller 32 in a variety of manners, such as being provided by other control systems of the vehicle, or directly from sensors such as wheel speed sensors, accelerometers, engine or transmission sensors, fuel throttle sensors or even external positioning systems such as GPS. Similarly, information on weather or road conditions 35 may be provided to the controller 32 in a variety of well known manners, such as through the use of satellite or radio broadcast, user input, vehicle sensors, optical sensors (i.e. rain sensors), the on/off condition of windshield wipers, or through user input. Still further, information on vehicle direction 36 may be provided to controller 32 in a variety of well known ways, such as through direct sensing of the wheels, the steering mechanism, or the steering wheel, through the use of GPS, or using other sensors such as lateral acceleration sensors or other vehicle dynamics sensors which may be employed to determine when the vehicle is turning or otherwise heading in a straight direction. User input 38 is provided to the controller 32, generally to manually control operation of the lighting system 20 and indicate when a high beam mode is desired or a low beam mode, but may also include user inputs of vehicle speed 34, weather or road conditions 35, or vehicle direction 36.

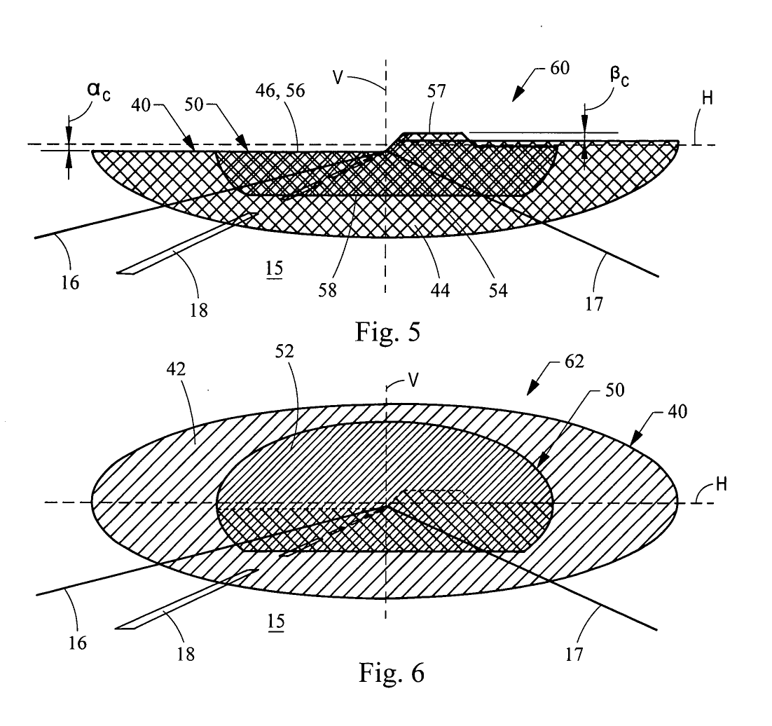

The beam patterns of the light units 26, 28, 30 will now be described with reference to FIGS. 2-4, and then operation of the light assemblies 22, 24 by the controller 32 will be described with reference to FIGS. 5-10. FIG. 2 depicts the beam pattern 40 of the primary light units 26. The primary beam pattern 40 is projected from the vehicle 14 onto the road 15 on which it is driving, and relative to a vertical axis V and horizontal axis H. It will also be recognized that the road 15 includes a left curb 16, right curb 17 and center line 18. Generally, the beam pattern 40 of the primary light units 26 include a high beam 42 encompassing the entire oval area depicted in FIG. 2, while a low beam 44 is provided which generally exists below the horizontal axis H (and indicated by the cross-hatching). That is, the low beam 44 includes an upper vertical cut-off 46. The left side of upper vertical cut-off 46 is slightly below the horizontal axis H, preferably by a degree ab which is equal to about 0.75 to 1.25 degrees. The right side of upper vertical cut-off 46 is preferably substantially aligned with the horizontal axis H. As depicted, the high beam 42 has a vertical spread extending between vs upper and vs lower, and similarly has a horizontal spread extending between hs_{left} and hs_{right}. Preferably, the horizontal spread is spans about 50 to 90 degrees. The term “about” is used loosely herein to mean within a few percent (i.e. within 3 percent).

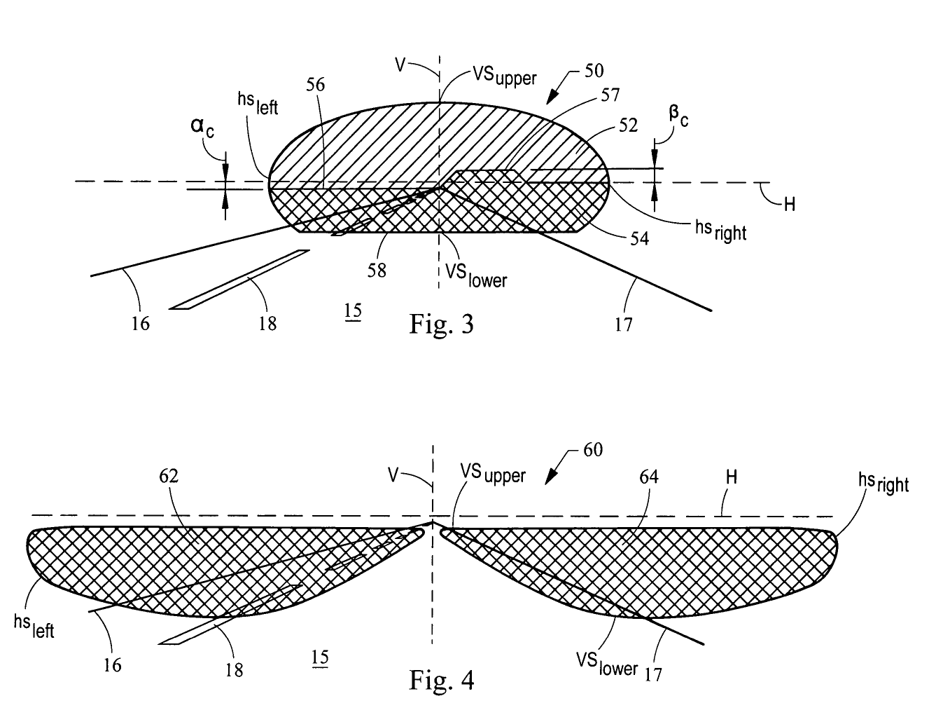

Turning now to FIG. 3, the beam pattern 50 produced by the secondary light units 28 has been depicted as projected in front of the vehicle 14 onto the road 15, and relative to vertical V and horizontal H. This secondary beam pattern 50 generally includes a high beam 52 covering the entire hatched area of FIG. 3. That is, the high beam 52 includes a vertical beam spread extending between vs upper and vs lower, and likewise includes a horizontal beam spread extending between hs_{left} and hs_{right}. The secondary beam pattern 50 has a horizontal spread preferably in the range of about 25 to 45 degrees. Notably, the beam pattern 50 includes a lower vertical cut-off 58 which is preferably a horizontal line generally parallel to horizontal H. As will be discussed in further detail below, the provision of lower vertical cut-off 58 to the beam pattern 50 of the secondary light units 28 assists in reducing road glare. The beam pattern 50 of the secondary light units 28 also includes a low beam 54 which generally includes an upper vertical cut-off 56. As with the primary beam pattern 40, the upper vertical cut-off 56 is slightly below horizontal H on the left side of vertical V, indicated in FIG. 3 by α_{c} and preferably equal to about 0.25 to 0.75 degrees. The right side of upper vertical cut-off 56 preferably includes a step 57 extending slightly above horizontal H, indicated by β_{c} and preferably in the range of about 0.5 to 1.5 degrees, to improve visibility on the right side and corresponding road signs.

Turning now to FIG. 4, the beam pattern 60 produced by the tertiary light units 30 have been depicted as projected from the vehicle 14 onto the road 15 and relative to vertical V and horizontal H. Generally, the tertiary beam pattern 60 includes a left pattern 62 produced by left tertiary light unit 30, and a right beam pattern 64 produced by a right tertiary light unit 30. The left and right beam patterns 62, 64 are positioned below horizontal H, and include a vertical spread extending between vs upper and vs lower. Generally, the left beam pattern 62 is to the left of vertical V, while the right beam pattern 64 is positioned to the right of vertical V. It will also be seen that the beam pattern 60 produced by the tertiary light units 30 thus includes a horizontal spread extending between hs_{left} of the left beam pattern 62 hs_{right} of the right beam pattern 64. Preferably, hs_{left} and hs_{right} are at least about 60 degrees from vertical V.

Through the provision of three distinctive beam patterns 40, 50, 60 provided by primary, secondary and tertiary light units 26, 28, 30, the controller 32 may operate the light units in different combinations to produce particular beam patterns based on inputted variables. For example, when vehicle speed 34 is below a predetermined value such as about 40 kmph to 100 kmph (25 mph to 62 mph) the controller 32 may only energize the primary light units 26 to produce the basic beam pattern 40 depicted in FIG. 2. User input 38 may operate the primary light units 26 through controller 32 to switch between high beam 42 and low beam 44. However, when vehicle speed 34 is at or above the predetermined level, the controller 32 may energize both the primary light units 26 and the secondary light units 28 to produce a high speed beam pattern 60, 62 depicted in FIGS. 5 and 6.

With reference to those figures, FIG. 5 depicts the high speed, low beam, beam pattern 60 which is produced by the combination of the beam pattern 40 of the primary light units 26, as well as the beam pattern 50 of the secondary light units 28. Specifically, the low beam 44 of the primary beam pattern 40 is combined with the low beam 54 of the secondary beam pattern 50. Preferably, the upper vertical cut-offs 46, 56 of the two beam patterns are vertically aligned to the left of vertical V and at the position α_{c} previously described as about 0.25 to 0.75 degrees below horizontal H. It will be recognized that through use of the secondary beam pattern 50 having a smaller horizontal spread, and especially the lower vertical cut-off 58 positioned well above a lower edge of the primary beam pattern 40, the glare on opposing traffic is significantly reduced, as is road glare from foreground illumination. FIG. 6 depicts the high speed, high beam, beam pattern 62 provided by the combination of high beams 42, 52 of the primary and secondary beam patterns 40, 50. It will be recognized that the secondary beam pattern 50 is circumscribed by the primary beam pattern 40, and similar benefits are achieved to that of the high speed, low beam, beam pattern 60 described above with reference to FIG. 5.

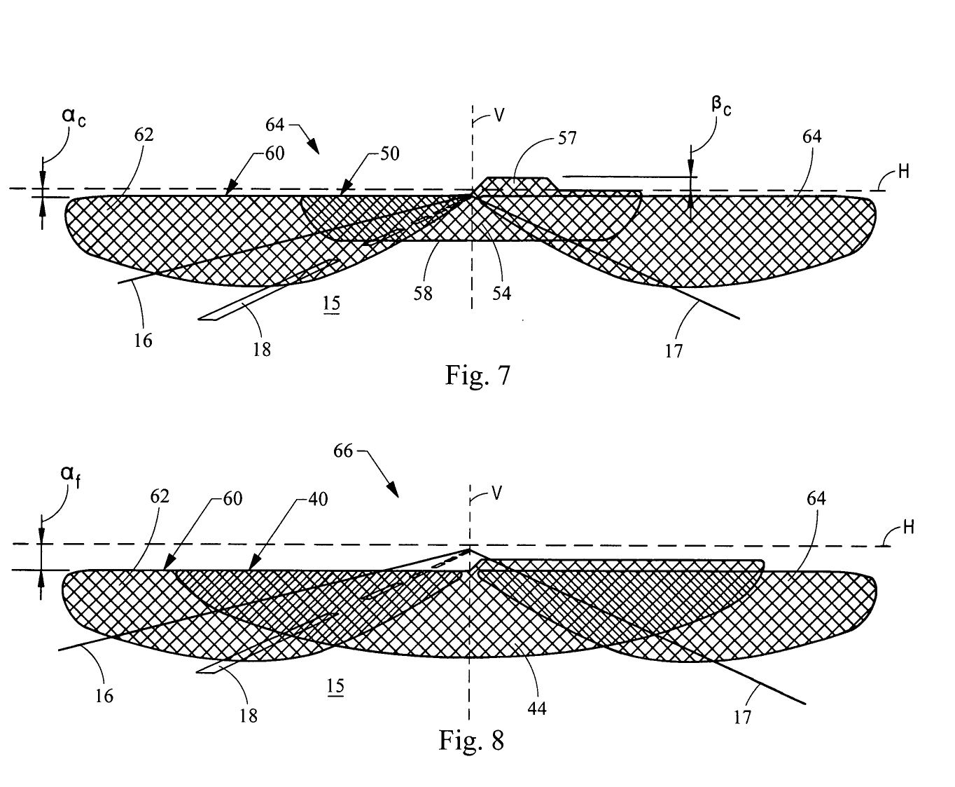

Turning now to FIG. 7, a wet road beam pattern 64 is produced by the combination of low beam 54 of secondary beam pattern 50, and the left and right low beam 62, 64 of tertiary beam pattern 60. When the controller 32 receives weather information 35, user input 38 or any other indication of wet conditions (or snow or other adverse driving conditions) H will energize secondary and tertiary light units 28, 30 to produce wet road beam pattern 64. Again, through use of the secondary light units 28 and their beam pattern 50 having a smaller horizontal spread and strategically positioned lower vertical cut-off 58, glare to opposing traffic is reduced through the limitation on foreground illumination at a bottom portion of the wet road beam pattern 64.

When the controller 32 receives weather information 35 or user input 38 indicating fog, a fog beam pattern 66 may be produced as shown in FIG. 8. Generally, the fog beam pattern 66 includes the combination of low beam 44 from beam pattern 40 of primary light units 26, in combination with the beam pattern 60 of tertiary light units 30 including both left beam 62 and right beam 64. It can also be seen that the left side of beam patterns 40 and 60 are aligned, preferably at α_{f} which is in the range of about 1 to 3 degrees below horizontal H, thereby improving the road 15 illumination during adverse whether such as fog.

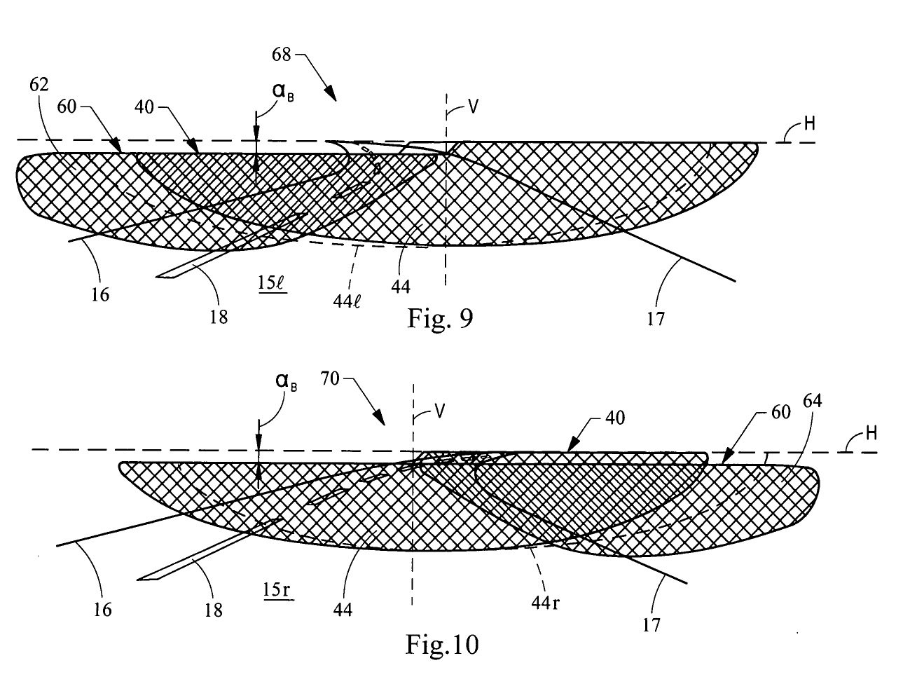

It can also be seen that the controller 32 can tailor the operation of light units 22, 24 based on the direction 36 of the vehicle 14. For example, when the road 15l turns to the left as depicted in FIG. 9, and thus the vehicle 14 is steered to the left, a left beam pattern 68 may be provided through the combination of left beam 62 of tertiary beam pattern 60 and low beam 44 of primary beam pattern 40. It will also be recognized that when primary light units 26 are steerable (i.e. may be rotated to the left and right as previously discussed), the low beam 44 of primary beam pattern 40 may likewise be shifted to the left as indicated by dotted line 44e. Preferably the left side of beam patterns 40 and 60 are vertically aligned as indicated by α_{b}. In this manner, increased illumination to the left of vertical V may be provided by the lighting system 20 of the present invention.

A similar principle may be applied to provide a right beam pattern 70 as depicted in FIG. 10. As with the left beam pattern 68, the right beam pattern 70 includes the combination of low beam 44 of primary beam pattern 40 with right beam 64 of tertiary beam pattern 60. This provides better illumination of a road turning to the right 15r, and likewise may be supplemented by a rotating primary light unit 26 which permits shifting of primary beam pattern 40 to right as depicted by dotted line 44r. Preferably, the left beam pattern 68 and right beam pattern 70 are only employed when the vehicle speed 34 is below the predetermined value, although these beams 68, 70 may be employed at high speed and likewise may be modified to include the high beam 42 of primary beam pattern 40.

Accordingly, it will be recognized by those skilled in the art that through the use of primary, secondary and tertiary light units 26, 28, 30 in each left and right light assembly 22, 24, the particular shape of their beam patterns 40, 50, 60 and the selective energization of these light units by a controller 32 receiving various inputs on speed 34, weather 35, direction 36 and user input 38, unique beam patterns 40, 60, 62, 64, 66, 68, 70 may be employed and adapted to various driving situations and conditions to improve illumination of the road and reduce glare to oncoming traffic.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A lighting system for a motor vehicle defining a vertical axis and a horizontal axis, the lighting system comprising:
a left light assembly having a primary light unit and a secondary light unit;
a right light assembly having a primary light unit and a secondary light unit;
the primary light units producing a beam pattern including a high beam and a low beam;
the secondary light units producing a beam pattern including a low beam;
a controller operatively connected to the left and right light assemblies for controlling the operation of the primary and secondary light units, the controller receiving information on a speed of the vehicle; and
the controller energizing only the primary light units when the vehicle speed is below a predetermined speed value, the controller energizing both the primary light units and the secondary light units when the vehicle speed is at or above the predetermined speed value.

2. The lighting system of claim 1, wherein the predetermined speed value is in the range of 40 kmph to 100 kmpg (about 25 mph to 62 mph).

3. The lighting system of claim 1, wherein the beam pattern of the primary light units circumscribes the beam pattern of the secondary light units.

4. The lighting system of claim 1, wherein the left and right light assemblies each include a tertiary light unit, the tertiary light units each producing a beam pattern including a low beam being substantially to the left and right, respectively, of the vertical axis.

5. The lighting system of claim 4, wherein the controller receives information on a direction of the vehicle, and wherein the controller energizes the tertiary light unit of the left light assembly when the vehicle turns left, and energizes the tertiary light unit of the right light assembly when the vehicle turns right.

6. The lighting system of claim 5, wherein the controller energizes the tertiary light unit of the left light assembly when the vehicle turns left and the vehicle speed is below a predetermined value, and energizes the tertiary light unit of the right light assembly when the vehicle turns right and the vehicle speed is below a predetermined value.

7. The lighting system of claim 5, wherein the primary light units are pivotably mounted and operated by the controller, and wherein the controller rotates the primary light units to the left when the vehicle turns left, and wherein the controller rotates the primary light units to the right when the vehicle turns right.

8. The lighting system of claim 4, wherein the controller receives information on weather affecting the vehicle, and wherein the controller energizes only the secondary light units and the tertiary light units when there are wet conditions, and wherein the controller energized only the primary light units and the tertiary light units when there are fog conditions.

9. A lighting system for a motor vehicle defining a vertical axis and a horizontal axis, the lighting system comprising:
a left light assembly having a primary light unit and a secondary light unit;
a right light assembly having a primary light unit and a secondary light unit;
the primary light units producing a beam pattern including a high beam and a low beam;
the secondary light units producing a beam pattern including a low beam; and
the beam pattern of the secondary light units having a lower vertical cut-off above a lower edge of the beam pattern of the primary light units.

10. The lighting system of claim 9, wherein the lower vertical cut-off is linear.

11. The lighting system of claim 9, wherein the lower vertical cut-off is about 5 to 10 degrees below the vertical axis.

12. The lighting system of claim 9, wherein a vertical beam spread of the secondary light units is less than a vertical beam spread of the primary light units.

13. The lighting system of claim 9, wherein a horizontal beam spread of the secondary light units is less than a horizontal beam spread of the primary light units.

14. The lighting system of claim 9, wherein the horizontal beam spread of the secondary light units is about 34 to 62 degrees, and wherein the horizontal beam spread of the primary light units is about 50 to 90 degrees.

15. The lighting system of claim 9, wherein the secondary light units produce a beam pattern including a low beam and a high beam.

16. The lighting system of claim 9, wherein the beam pattern of the primary light units is centered on the horizontal and vertical axes, and wherein the beam pattern of the secondary light units is centered on the horizontal axis.

17. The lighting system of claim 9, wherein the left and right light assemblies each include a tertiary light unit, the tertiary light units each producing a beam pattern including a low beam being substantially to the left and right, respectively, of the vertical axis.

18. The lighting system of claim 17, wherein the beam pattern of each tertiary light unit extend horizontally to a point at least 60 degrees from the vertical axis.

19. The lighting system of claim 17, wherein the beam pattern of the tertiary light units has a horizontal spread greater than a horizontal spread of the beam pattern of the primary light units.

20. A lighting system for a motor vehicle defining a vertical axis and a horizontal axis, the lighting system comprising:
a left light assembly having a primary light unit, a secondary light unit, and a tertiary light unit;
a right light assembly having a primary light unit, a secondary light unit and a tertiary light unit;
the primary light units producing a beam pattern including a high beam and a low beam;
the secondary light units producing a beam pattern including a low beam; and
the tertiary light units each producing a beam pattern including a low beam being substantially to the left and right, respectively, of the vertical axis;
a horizontal beam spread of the secondary light units being less than a horizontal beam spread of the primary light units; and
a horizontal beam spread of the tertiary light units being greater than the horizontal beam spread of the primary light units.
